(19) United States
(12) Patent Application Publication
(10) Pub. No.: US 2022/0397461 A1
(43) Pub. Date: Dec. 15, 2022

(54) Thermal Insulated Metallic Housing Comprising Internal Shell

(71) Applicants: MEAS France, Toulouse (FR); Tyco Electronics Hungary Termelo Korlatolt Felelossegu Tarsasag, Esztergom (HU)

(72) Inventors: Bastien Venet, Bailly-Romainvilliers (FR); Nicolas Christopher Pecquet, Bailly-Romainvilliers (FR); Alexandra Da Cruz, Bailly-Romainvilliers (FR); Paul Wafo, Toulouse (FR); David Trexler, Esztergom (HU)

(73) Assignees: MEAS France, Toulouse (FR); Tyco Electronics Hungary Kft., Esztergom (HU)

(21) Appl. No.: 17/840,938

(22) Filed: Jun. 15, 2022

(30) Foreign Application Priority Data
Jun. 15, 2021 (EP) 21305816.7

(51) Int. Cl. G01K 1/143; G01K 7/22; G01K 1/08

(52) U.S. Cl. CPC G01K 1/143; G01K 7/22; G01K 1/08

(57) ABSTRACT

A temperature sensor device for sensing a temperature of a surface of an object includes a temperature sensor element being or comprising a thermistor and a housing having a measuring cavity in which the temperature sensor element is disposed. The housing has a measuring surface contacting the surface of the object, an outer shell, an inner shell, and an outer cavity formed between the outer shell and the inner shell. The outer shell, the inner shell, and the outer cavity thermally insulate the measuring cavity and the measuring surface from an environment of the object.

### CROSS-REFERENCE TO RELATED APPLICATIONS

This application claims the benefit of the filing date under 35 U.S.C. § 119(a)-(d) of European Patent Application No. 21305816.7, filed on Jun. 15, 2021.

### FIELD OF THE INVENTION

The present invention relates to a temperature sensor device for sensing the temperature of a surface of an object and, in particular, a temperature sensor device comprising a housing for thermally insulating a measuring surface of the temperature sensor device from an environment of the object.

### BACKGROUND

Temperature sensors are of use in a great variety of applications including, for example, automotive applications. Temperature sensors can, for example, be used in the context of industrial condition monitoring or for controlling the operation of combustion engines and means operatively connected therewith or as windshield sensing devices installed in vehicles for the purpose of automatically controlling the heating, ventilation, air conditioning and operation of the windshield wiper.

For allowing a precise and reliable monitoring of the temperature of (a surface of) an object, the sensor of the sensing device must be reliably kept in constant contact with the surface of the object and often has to withstand mechanical shocks and vibrations over the entire lifetime. Further, it must be avoided that the temperature measurement is affected by the temperature of an environment of the object.

In the art, sensor devices comprising printed circuit boards (PCBs) are known. For example, a thermistor is attached to a flexible polyimide film. One end of the polyimide film is connected to a PCB and another end, on which the thermistor is attached, is attached to the object the temperature of which must be measured. In the art, thermal insulation elements are provided to reduce the influence of the environment of the object on the actual temperature measurement. The known thermal insulation elements, for example, insulation sleeves, are relatively bulky and subject to severe deterioration by aging effects (for example, caused by vibration, thermal influences, solar radiation, humidity, etc., in particular when the thermal insulation elements comprise organic materials.

### SUMMARY

A temperature sensor device for sensing a temperature of a surface of an object includes a temperature sensor element being or comprising a thermistor and a housing having a measuring cavity in which the temperature sensor element is disposed. The housing has a measuring surface contacting the surface of the object, an outer shell, an inner shell, and an outer cavity formed between the outer shell and the inner shell. The outer shell, the inner shell, and the outer cavity thermally insulate the measuring cavity and the measuring surface from an environment of the object.

### BRIEF DESCRIPTION OF THE DRAWINGS

The invention will now be described by way of example with reference to the accompanying Figures, of which:

FIG. 1 is a schematic sectional view of a temperature sensor device according to an embodiment; and

FIG. 2 is a schematic side view of the temperature sensor device.

### DETAILED DESCRIPTION OF THE EMBODIMENT(S)

Features and advantages of the present invention will be described with reference to the drawings. In the description, reference is made to the accompanying figure that is meant to illustrate embodiments of the invention. It is understood that such embodiments do not represent the full scope of the invention.

The present invention provides a temperature sensor device for sensing the temperature of a surface of an object, for example, a pipe or a windshield of a vehicle, wherein the temperature sensor device comprises a housing having multiple shells for thermally insulating a sensor element/measuring surface from an environment of the object. The provided temperature sensor device may be suitably used for sensing a large range of temperatures, for example, from −200° C. to 1000° C.

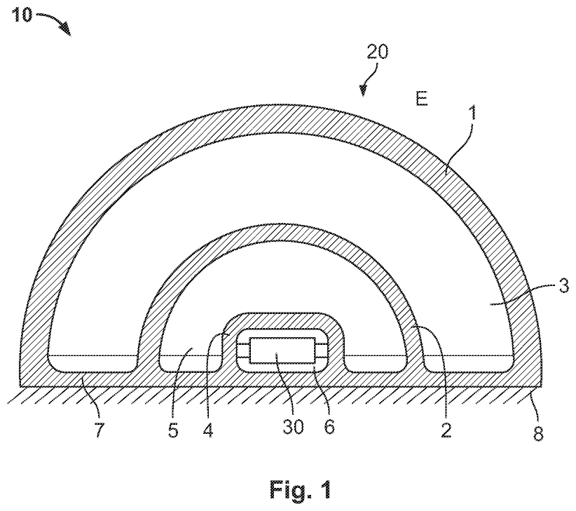

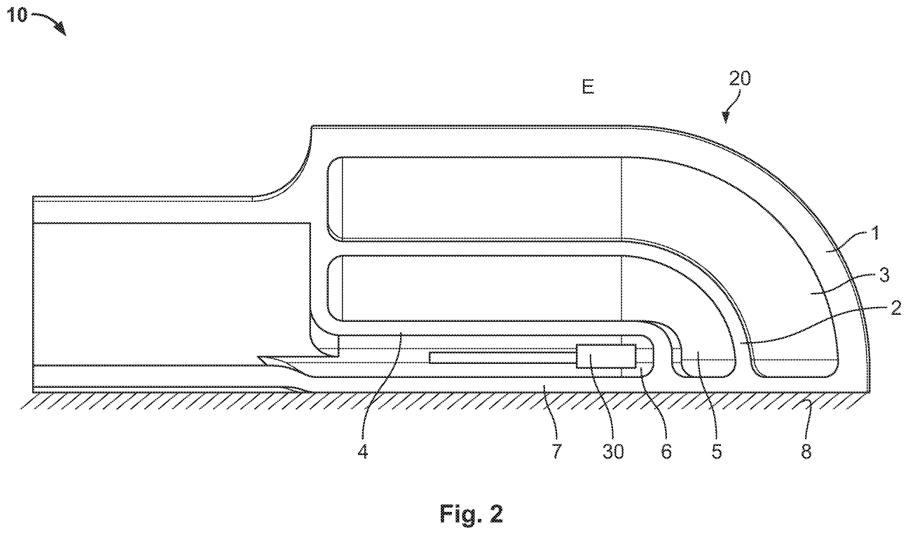

FIGS. 1 and 2 show an embodiment of a temperature sensor device 10 according to the invention. The temperature sensor device 10 shown in FIGS. 1 and 2 comprises a housing 20. The housing 20 provides protection against pollution and chemical and physical environmental conditions. The housing 20 comprises an outer shell 1 and at least one inner shell 2. An outer cavity 3 is formed between the outer shell 1 and the inner shell 2. Both the outer shell 1 and the inner shell 2 may be made of or comprise a metal material, for example, stainless steel, titanium, aluminum alloy, copper alloy, an iron alloy as maraging steel or an austenitic nickel-chromium-based superalloy—Inconel®. The outer shell 1 and the inner shell 2 may be made of or comprise the same metal material and may be formed in a single manufacturing step, for example, by (powder-based) 3D metal printing. The 3D metal printing may be performed by a Direct Metal Laser Sintering (DMLS) device. One or more apertures may be formed in the inner shell 2 to remove 3D printing powder after the completion of the forming of the inner shell 2. Alternatively, the housing 20 or the outer shell 1 and the inner shell 2 may be manufactured by (metal) injection molding, for example. In another embodiment, the outer shell 1 and the inner shell 2 may be made of different materials.

More than one inner shell 2 may be provided that are separated from each other by cavities. The outer shell 1 and/or the inner shell 2 may have a less than full spherical or hemispherical shape (with full or partial hemispheres) that might be advantageous in terms of creating a compact design on the temperature sensor device 10 and mechanical stability. Depending on the actual application of the temperature sensor device 10, rectangular shapes might also be considered suitable.

Further, the temperature sensor device 10 comprises a temperature sensor element 30, as shown in FIGS. 1 and 2. The temperature sensor element 30 may comprise or may be a thermistor or a resistive temperature detector or a silicon-based semi-conductor temperature sensor or a thermocouple. The temperature sensor element 30 may have electrically conductive leads to transduce a sensed temperature into an electrical output signal.

The outer shell 1 is closer to an environment E of the temperature sensor device 10 than the inner shell 2 and is in direct contact with the environment E. The inner shell 2 is closer to the temperature sensor element 30 than the outer shell. The outer shell 1 and the inner shell 2 may be arranged concentrically to each other.

An inner cavity 5 is formed between the inner shell 2 and a measuring cavity shell 4. The measuring cavity shell 4 may be made of or comprise a metal material for relatively high thermal conductivity, for example, stainless steel, an iron alloy as maraging steel or an austenitic nickel-chromium-based superalloy—Inconel® and, for example, the same material as the outer shell 1 and the inner shell 2. In another embodiment, the measuring cavity shell 4 may be made from a different material than the outer shell 1 and the inner shell 2. In an embodiment, the measuring cavity shell 4 may be manufactured in the same single manufacturing step as the outer shell 1 and the inner shell 2, for example, by (powder-based) 3D metal printing or injection molding. The outer shell 1 and the inner shell 2 and the measuring cavity shell 4 may have less than full spherical or hemispherical shapes (with full or partial hemispheres).

Moreover, the measuring cavity shell 4 defines a measuring cavity 6, the bottom of which is formed by or comprises or is connected to a measuring (sensing) surface 7. The temperature sensor device 10 may be configured for sensing the surface temperature of an object based on the measurement of an electrical current flowing in or an electrical resistance or a voltage provided by the measuring surface 7. In order to sense the surface temperature of an object, the measuring surface 7 is in contact (for example, planar contact) with a surface 8 of the object. The measuring surface 7 may be part of the housing 20. It is noted that there is no direct mechanical/thermal contact between the measuring cavity shell 4 and the surface 8 of the object the surface temperature of which is to be measured by the temperature sensor device 10.

The measuring surface 7 may be part of a thermally conductive pad by which the temperature sensor is attached to the object. The geometric shape of the measuring surface 7 may be adapted to the surface 8 of the object the surface temperature of which is to be measured. For example, a planar or curve (convex or concave) measuring surface 7 may be provided. The measuring surface 7 and the outer shell 1 or the measuring surface 7 and the outer shell 1 and the inner shell 2 or the measuring surface 7, the outer shell 1, the inner shell 2 and the measuring cavity shell 4 may be made of one single integrally formed piece. For example, the thickness of one or more of the measuring cavity shell 4, the inner shell 2, and the outer shell 1 is in the range of 0.1 to 1.5 mm.

The temperature sensor device 10 may be connected to a printed circuit board (PCB) comprising a measurement and control circuitry for processing data sensed by the temperature sensor element 30 and for controlling the temperature sensor device 10. In principle, wired and wireless configurations with or without PCB may be implemented. In principle, the temperature sensor device 10 may also be used in combination with one or more sensors configured for sensing measurands different from temperature.

The housing 20 provides thermal insulation of the measuring cavity 6/temperature sensor element 30/measuring surface 7 from an environment E (for example, surrounding air) of the object (and the temperature sensor device 10) such that the measurement of the surface temperature of the object is less affected by the temperature of the environment E (i.e., any temperature offset is significantly reduced by the provision of the housing 20).

No additional insulating material/elements (in particular, no relatively bulky organic or inorganic insulating elements) are needed in addition to the housing 20 shown in FIGS. 1 and 2 in order to achieve the desired thermal insulation. However, according to particular embodiments, one or more of the measuring cavity 6, the inner cavity 5, and the outer cavity 3 may be filled with some gas or a material of less thermal conductivity than the thermal conductivities of the outer shell 1 and the inner shell 2 or one or more of the measuring cavity 6, the inner cavity 5 and the outer cavity 3 may be applied to vacuum. According to a particular embodiment, the measuring cavity 6 and the inner cavity 5 are filled with different materials. For example, it might be suitable to fill the measuring cavity 6 and the inner cavity 5 with a polymer material, for example, when negative temperatures are to be measured.

The housing 20 has at least three cavities, one of which (the measuring cavity 6) is provided for the temperature sensor element 30 that is covered by the housing 20 and the other two cavities (the inner and outer cavities 3, 5) being formed over the measuring cavity shell 4 and being provided for thermal management in the housing 20. In the configuration shown in FIGS. 1 and 2, the inner shell 2 provides an efficient thermal convection barrier (substantially blocking vertical flow of heat) as well as a thermal radiation barrier (substantially blocking radial flow of heat) between the outer cavity 3 and the inner cavity 5, thereby minimizing temperature gradients in these regions of the temperature sensor device 10 in order to provide for accurate temperature measurements by the temperature sensor device 10. Due to the contact of the inner shell 2 with the measuring surface 7, heat can be conducted from or to the measuring surface 7, and, thus, temperature gradients over the measuring cavity 6 defined by the measuring cavity shell 4 and the inner cavity 5 defined by the measuring cavity shell 4 and the inner shell 2 can be reduced.

The temperature sensor device 10 can be manufactured relatively simply and at relatively low costs with a compact size. Depending on the choice of the material used for the formation of the outer shell 1, the temperature sensor device 10 can reliably operate in relatively low temperature environments (for example, at temperatures as low as −200° C.) and high temperature environments (with temperatures of some 100° C. or some 1000° C. or more). Further, the temperature sensor device 10 can reliably operate in chemically and physically harsh environments and, in particular, can stand mechanical vibrations. For example, the temperature sensor device 10 can be used for sensing the temperature of exhaust gases of combustion engines of vehicles (via a surface of an object, for example, some pipe, in thermal contact with the exhaust gas).

All embodiments of the above-described temperature sensor device 10 may be used in automotive and industrial applications, for example. A combustion engine control device for controlling the operation of a combustion engine and, in particular, the temperature of an exhaust gas produced by the combustion engine, may comprise the temperature sensor device 10.

Furthermore, a defogging control device or a wiper operation control device for a motor vehicle comprising a windshield is provided, the defogging control device or the wiper operation control device comprising a humidity sensor device for sensing the humidity of the windshield and the temperature sensor device 10.

All previously discussed embodiments are not intended as limitations, but serve as examples illustrating features and advantages of the invention. It is to be understood that some or all of the above-described features can also be combined in different ways.

What is claimed is:

1. A temperature sensor device for sensing a temperature of a surface of an object, comprising:
a temperature sensor element being or comprising a thermistor; and
a housing having a measuring cavity in which the temperature sensor element is disposed, a measuring surface contacting the surface of the object, an outer shell, an inner shell, and an outer cavity formed between the outer shell and the inner shell, the outer shell, the inner shell, and the outer cavity thermally insulate the measuring cavity and the measuring surface from an environment of the object.

2. The temperature sensor device of claim 1, wherein the housing is integrally formed in a single piece.

3. The temperature sensor device of claim 1, wherein the housing has a measuring cavity shell, the measuring cavity is formed between the measuring cavity shell and the measuring surface.

4. The temperature sensor device of claim 1, wherein the housing has an inner cavity between the inner shell and the measuring cavity shell.

5. The temperature sensor device of claim 1, wherein the outer shell and the measuring surface are integrally formed in a single piece.

6. The temperature sensor device of claim 3, wherein the measuring cavity shell, the inner shell, and the outer shell are integrally formed in a single piece.

7. The temperature sensor device of claim 3, wherein the measuring cavity shell, the inner shell, the outer shell, and the measuring surface are integrally formed in a single piece.

8. The temperature sensor device of claim 4, wherein the inner cavity and/or the outer cavity is filled with a gas or a material of less thermal conductivity than a thermal conductivity of the outer shell and the inner shell.

9. The temperature sensor device of claim 4, wherein the inner cavity and/or the outer cavity is a vacuum.

10. The temperature sensor device of claim 1, wherein the outer shell and/or the inner shell is made of or comprises a metal material.

11. The temperature sensor device of claim 10, wherein the outer shell and the inner shell are made of a same metal material.

12. The temperature sensor device of claim 1, wherein the inner shell contacts the measuring surface.

13. The temperature sensor device of claim 3, wherein the outer shell, the inner shell, and/or the measuring cavity shell has an at least partially hemispherical or rectangular shape.

14. The temperature sensor device of claim 1, wherein the measuring surface has a plane shape or a curved shape.

15. The temperature sensor device of claim 1, wherein the outer shell and the inner shell are manufactured by 3D metal printing, injection molding, or machining.

16. A method of manufacturing a temperature sensor device, comprising:
providing the temperature sensor device; and
manufacturing a housing by 3D metal printing, injection molding, or machining, the housing having an outer shell, an inner shell, a measuring cavity shell, and a measuring surface, the temperature sensor device is disposed in a measuring cavity defined by the measuring cavity shell and the measuring surface.
